(19) United States
(12) Patent Application Publication
(10) Pub. No.: US 2009/0119245 A1
(43) Pub. Date: May 7, 2009

(54) MANAGING DATA USING R-SMART CRITERIA

(75) Inventor: Thomas W. Lynch, Galveston, TX (US)

Correspondence Address: AMIN, TUROCY & CALVIN, LLP, 127 Public Square, 57th Floor, Key Tower, CLEVELAND, OH, 44114, US

(73) Assignee: LIANG HOLDINGS LLC, Wilmington, DE (US)

(21) Appl. No.: 11/936,704

(22) Filed: Nov. 7, 2007

(51) Int. Cl. G06F 17/30

(52) U.S. Cl. 707/1

(57) ABSTRACT

Implementations related to managing data on r-smart networks are disclosed.

### BACKGROUND

The management of stored information is becoming an increasingly important component of most people's lives. There is an increasing trend in the amount of information stored by people, and this has created new challenges for managing that information.

Some social scientists maintain that most social interaction has an emotional basis and that analytical considerations are secondary, if present at all. Whether justified or not, caring and emotions are frequently termed “right brain” activities, and hence being good at these activities is sometimes referred to as “r-smartness” which is short for “right brain smartness”.

People often use r-smartness in determining how they relate with other people. In some cultures this may be very pronounced, and may even affect the vocabulary and grammar of a conversation. For example, in pre-modern Europe, third person and indirect terms were used when conversing with royalty. As another example, in Japan different forms of address are used depending on whether one is speaking to children, family, co-workers, elders and bosses. Take for instance the Japanese word for thank you. It may take the form of “domo”, “domo arigato”, and “domo arigato gozaimasu” depending on the perceived acting role and status difference in the conversation. Thus, in this context, acting roles may include such things as parent-child, student-teacher, employee-boss, among others. Furthermore, status differences may be based on age, attainment in a skill, spiritual attainment, money, among others. Indeed, this also exists in a less formal form in American English with “thanks”, “thank you”, and “thank you very much” and other variations said in different tones and intonations. However, r-smartness comes into play in a variety of situations, not just when saying thank you.

A typical computer user is not a trained scientist or engineer. He or she rarely thinks about data in terms of hierarchy and categories, but rather in terms of how he or she feels about it. Thus, a user may look at a picture of a family reunion and think of family connection, an old article written for a school paper and feel nostalgic, feel that an article is insightful, that a joke is funny, or that a spreadsheet is necessary but boring material. Family, nostalgic, insightful, funny, boring but necessary—these may be categories that a typical user would associate data with. However, while information storage systems often permit stored items such as data to be sorted, searched and/or archived, conventional systems are limited in what criteria may be used to undertake such tasks and, hence, may not provide criteria that a typical user would want to employ.

### BRIEF DESCRIPTION OF THE DRAWINGS

Subject matter is particularly pointed out and distinctly claimed in the concluding portion of the specification. Claimed subject matter, however, both as to organization and method of operation, together with objects and features thereof, may best be understood by reference of the following detailed description if read with the accompanying drawings in which:

FIGS. 1 and 2 illustrate examples of contextual filtering of data;

FIGS. 3 through 7 illustrate example message headers;

FIG. 8 illustrates another example of contextual filtering of data;

FIG. 9 illustrates an example system; and

FIGS. 10 and 11 illustrate example methods.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the following detailed description are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical, magnetic and/or electromagnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

A data storage system may store items and may permit a user to sort, search and/or archive those items based upon particular criteria. In accordance with some implementations of claimed subject matter a user may sort, filter and/or archive items using r-smart criteria. In this disclosure, and the claims that follow, the phrase “r-smart criteria” may refer to emotient attributes associated with items where the phrase “emotient attributes” may refer to properties of familiarity, affection, respect, esteem, status, and/or acting role of entities, such as personal contacts, defined with respect to the user. In other words, emotient attributes may reflect how a user feels about an entity associated with a stored item or may feel about the item itself. For example, a user of a data storage system such as a computer hard-drive may hold photographs of the user's grandmother stored on the hard-drive in higher esteem than photographs of the user's cat that are also stored on the hard-drive. In such circumstances a user of a system in accordance with claimed subject matter may associate a different emotient attribute with pictures of the user's grandmother than with pictures of the user's cat.

In this disclosure, and the claims that follow, the term “contextual filtering” describes, at least in part, using r-smart criteria to manage stored data. In this context the terms “sorting” and “filtering” may be used interchangeably. In accordance with some implementations of claimed subject matter such “contextual filtering” need not be applied only to the sorting of items, it may also be applied to searching among items. Further, in this disclosure, and the claims that follow, the terms “manage” or “management” when employed in the context of contextual filtering describe, at least in part, searching, filtering, and/or archiving stored items.

Those skilled in the art will recognize that techniques for sorting, searching and/or archiving stored items are well established and that there are many well-known schemes for implementing data management and/or for providing a user with an interface for managing data and, hence, specific data management schemes and/or interfaces will not be described in detail herein. For example, common techniques for facilitating sorting, searching and/or archiving items include indexing meta data (e.g., file name, last access date, etc.) associated with the items and/or indexing item content. In addition, some schemes permit users to customize meta data by adding and/or altering keywords and/or tags that may also be indexed to facilitate sorting, searching and/or archiving items.

While claimed subject matter is not limited by the type of data associated with emotient attributes, in some implementations, stored message content and/or message-related data, may be sorted, searched and/or archived as a function of r-smart attributes associated with those items. For example, an email client may provide r-smart attributes associated with emails directly in the email headers and those attributes may be used to sort, search and/or archive emails. Further, in accordance with some implementations of claimed subject matter, a user may sort, search and/or archive items based on one or more “relationship ring” attributes of a message sender where those attributes may be conveyed in a header associated with the message.

As used throughout this disclosure and in the claims that follow, the phrase “relationship ring” may be used to describe a grouping of items sharing one or more emotient attributes in common. Claimed subject matter is not limited in this regard however, and, thus, a grouping of items in accordance with claimed subject matter may be described as a “ring”, a “group”, a “domain”, to name just a few examples. Thus, within this disclosure, use of the term “ring” should not be understood as describing a literal geometric shape, even though such shapes may be employed in network diagrams, etc., that may be used to illustrate example implementations of claimed subject matter.

In some implementations of claimed subject matter, items may be sorted, searched and/or archived in response to r-smart criteria using separate programs, or a combined program. Such a program or collection of programs may provide sorting, searching and/or archiving functions or utilities to a user and may be called an “emotience manager” although claimed subject matter is not limited in this regard. For example, an emotience manager may present a search function to a user permitting the user to enter and/or select r-smart criteria to be used for searching stored items. Similarly, such an emotience manager may present a sort function to a user permitting the user to enter and/or select r-smart criteria to be used for sorting or filtering stored items. Further, an emotience manager may present an archive function to a user permitting the user to enter and/or select r-smart criteria to be used for organizing the storage of items. In some implementations, an emotience data manager in accordance with claimed subject matter may enable users to attach properties such as emotient attributes to data items, enable users to set up inheritance and default rules (for communicated data for example), and to later search and retrieve items.

An emotience manager in accordance with claimed subject matter may include at least a portion of a graphical user interface (GUI) capable of being displayed on a display device. The particular form used may be a user preference, or even a function, for example, of a display device employed by a user. Further, an emotience manager may, in accordance with claimed subject matter, be accessed (e.g., for reading and/or editing) by software applications that are compatible with r-smart networks.

As mentioned above a user may utilize an emotience manager In accordance with claimed subject matter to sort or filter items. One possible filtering interface may comprise an interface that allows a user to explicitly sort or filter only items associated with particular emotient attributes. Such an interface may present a dialog box, and allow a user to enter criteria related to one or more attributes into the dialog box. The emotience manager may then filter items in response to the entered criteria. For example, in the context of relationship rings, a user may select both “family” and “business” rings and filter items associated with those rings for only those items associated with contacts that have the emotient attributes of being both friends and business associates of the user. A possible further extension of this implementation may interpret user input as a regular expression, and then present all matching categories. Clearly, those skilled in the art of data management will recognize that there are many ways to facilitate management of stored information and the above example is merely one way of doing so.

In some implementations of claimed subject matter, a user may selectively enable the display of items associated with particular emotient attributes. Thus, using again the example context of relationship rings, if a user is involved in a family event, he or she may configure an application to display only those stored items associated with members of a “family” ring of contacts. Likewise, for another example, when at the office, a user may configure an application to display only those stored items associated with members of that user's “office” ring of contacts.

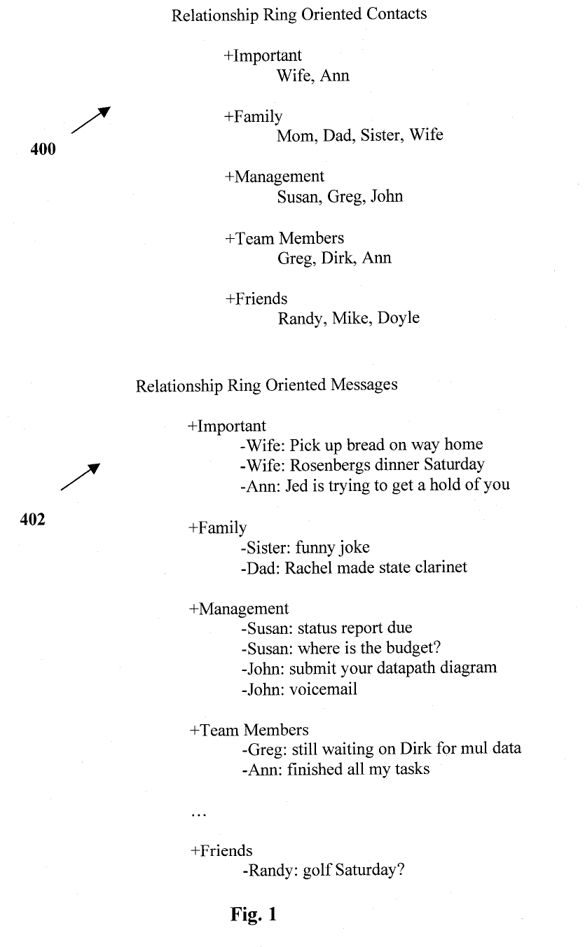

FIG. 1 illustrates, in accordance with an example implementation of claimed subject matter, contextual filtering of stored email items in the context of a contacts list organized as a relationship ring. On the left-hand side of FIG. 1 is shown a contacts list 400 organized as a relationship ring. While on the right-hand side is shown a representation 402 of the contents of an email inbox organized with respect to the relationship ring each sender of the mail belongs to. It should be understood, however, that FIG. 1 represents an illustrative example implementation and that no particular information shown therein should necessarily be construed as limiting claimed subject matter in any way. Also, it should be understood that claimed subject matter is directed to the management of stored data and is in no way limited to management of communications-related stored data.

In accordance with some implementations of claimed subject matter message display and/or search context may be undertaken according to emotient attributes such as relationship ring membership or ring name, etc. For instance, FIG. 2, in accordance with an example implementation of claimed subject matter, illustrates a user interface of an email application that has been configured to limit displayed items 500 to a particular context, in this example: items received from management contacts. Further, in the example of FIG. 2, an item search may also be similarly limited in scope to items associated with management messages. Once again, FIG. 2 represents merely an illustrative example implementation and no particular information shown therein should necessarily be construed as limiting claimed subject matter.

Further, in addition to contextual filtering employing user interfaces similar to the examples shown in FIGS. 1 and 2, there are many other interfaces that may be employed to provide contextual filtering in accordance with claimed subject matter. For example, contextual filtering in response to r-smart criteria may, in accordance with claimed subject matter, comprise employing an explicit statement of a text-string to search for. Thus, for example, with contextual filtering limited to items received from “management” ring contacts, a search may be undertaken for any and all occurrences of the text-string “meeting at 1 pm” associated with those items. Moreover, for example, when search activity is constrained to a particular ring (e.g., a “management” ring), a search for “pick up bread”, for example, may fail, as such content may be associated only with items originating from members of a “family” ring. In other implementations in accordance with claimed subject matter, display context and search context may not be linked and thus, using the above example, when a display context is constrained to a management ring, a search for “pick up bread” may not fail.

Some implementations in accordance with claimed subject matter may include special rings such as, for example, “everybody” and/or “nobody” rings where an everybody ring may comprise a flat contact list that includes all contacts, and a nobody ring may contain all contacts that do not belong to any other ring. Various implementations may give such special rings names other than “everybody” and “nobody”. In such implementations, contextual filtering may give rise to special item listings. For example, limiting item display to an everybody ring may result in display of all items, while limiting item display to a nobody ring may result in display of items received from contacts who are either not in a contacts list, or who are in a contacts list, but have not been assigned to any relationship rings.

In accordance with claimed subject matter, emotient attributes may be associated with items when those items are stored so that the items, as stored, are arranged with respect to their emotient attributes. In other words, items sharing emotient attributes in common can be stored in association with each other. In other implementations of claimed subject matter, previously stored items may be subsequently associated with emotient attributes. As those skilled in the art may recognize, associating storing items with each other may mean that the items are stored in physical association with each other (e.g., in adjacent regions of memory for example) and/or it may mean that items are stored in logical association with each other, or, in other words, that within storage system the items may be associated with each other by associated each item with, for example, a common index.

Implementations of claimed subject matter are not limited to management of items associated with communications, but may include sorting, searching and/or archiving of stored items of any type and/or origin, such as, for example, digital images, application files, etc. However, within the context of communications-related items, and in accordance with some implementations of claimed subject matter, the identification associated with the sender of an item (e.g., a caller's identification) may be searched against a user's contact information to determine a relationship ring and/or a role to be associated with the item. A message sender may have volunteered, or have been prompted to supply, disambiguating information should the sender have more than one role and/or belong to more than one relationship ring. Thus, for example, an emergency contact that is also a friend could distinguish between an emergency message and a friendly message. Similarly, a wife who is also a business partner, may categorize messages into one or both roles. In such circumstances, sorting, searching and/or archiving items in response to r-smart criteria related to one role or another role may, in accordance with claimed subject matter, involve sorting, searching and/or archiving items associated with the same stored message or messages.

Further, roles associated with contacts may be hierarchical. Thus, for example, a spouse who is also a business partner may further distinguish messages associated with the business partner role based on marketing or sales, for example.

In addition, in some implementations of claimed subject matter, a recipient of an item may re-categorize the emotient attribute or attributes, such as an acting role or roles, associated with the item. Moreover, in some implementations, a user may highlight or otherwise flag one or more portions of a message and may limit categorization to those portions. Highlighted portions may then be display by themselves or as highlighted sections when items are filtered by emotient attributes.

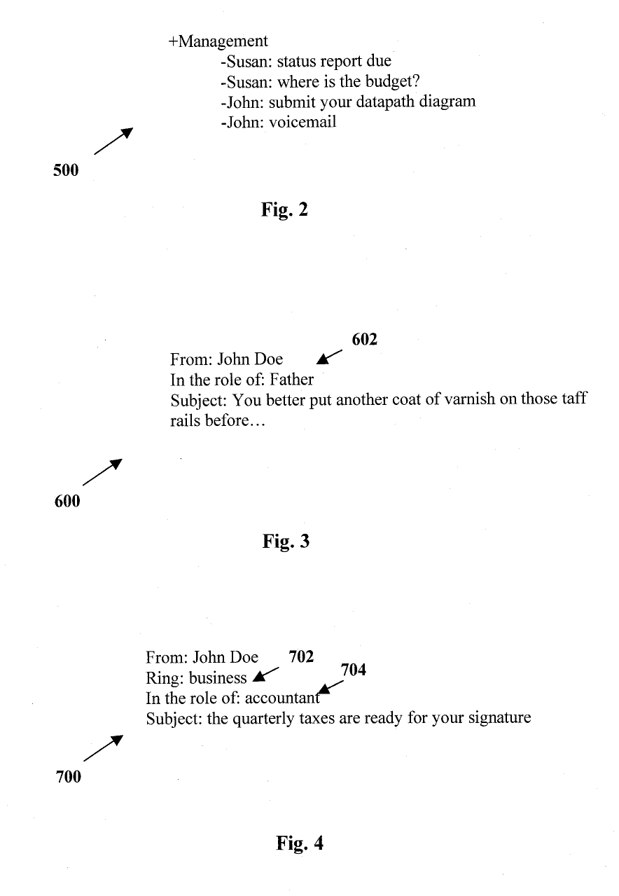

FIGS. 3 and 4 illustrate an example implementation wherein a contact “John Doe” belongs to two rings: a “family business” ring, and a “family member” ring. In the example implementation of FIGS. 3/4 an email application may support, in accordance with claimed subject matter, use of email keywords for the purpose of disambiguating messages. Thus, in FIG. 3, contact John Doe has added a header key 602 to signify the role from which he is speaking in the stored item 600. While in FIG. 4, the contact has, associated with a item 700, provided both a key 702 for the ring he belongs to on the receiver's email application, and has provided a key 704 for his role. Hence, in accordance with claimed subject matter, sorting, searching and/or archiving items associated with item 600 may be undertaken in response to criteria including either or both of keys 702 and 704.

While r-smart criteria may be utilized, as described in various examples above, to filter or search items, in addition, r-smart criteria may also be used to archive items in accordance with claimed subject matter. Thus, in accordance with claimed subject matter, a user may employ r-smart criteria to organize or otherwise specify certain stored items as belonging to a specific collection of items. For example, a user may wish to organize all stored items relating to a particular r-smart criteria such as all items received from contacts that are both held in particular esteem by the user and that share a common acting role (e.g., messages from co-workers that are also friends of the user). The user may then search stored items using a search string that includes the r-smart criteria of “co-worker” and “friend”, retrieve the results of the search and then store the retrieved items together as an archived collection.

Emotient attributes associated with stored items may, in some implementations in accordance with claimed subject matter, be used to provide an enhanced communications list. In some implementations, for example, an address, such as an email address, may be associated with an emotient attribute such as the name of a relationship ring, and, thus, by using that address a communication may be sent to every contact that belongs to the associated ring. Thus, for example, a user who has defined a “family” ring may send email to the members of that ring with a single mail header. For instance, FIG. 5 illustrates, in accordance with claimed subject matter, an example email header 800 directed to a “family” ring.

While relationship rings in accordance with claimed subject matter may be defined locally to a particular user and/or application, in some implementations in accordance with claimed subject matter, a user of a relationship ring system may want to share his or her ring definitions with other users.

Thus, in some implementations of claimed subject matter features may allow ring definitions to be sent to and integrated on a remote system. In some implementations, ring definitions may be automatically sent to and integrated on a remote system. In some implementations ring definitions may comprise a ring name and associated properties and may comprise ASCII text although claimed subject matter is not limited to any particular ring definition format. In some implementations, a ring definition may be sent as an attachment to a message.

Yet further, in some implementations of claimed subject matter, a message sender may remain anonymous and/or the sender's identity may comprise the sender's ring membership. For example, a sender may belong to a ring such as a committee ring, and the sender may wish to send a document resulting from a group effort. In this context the sender may be identified by the committee ring name. Another example may be where the sender is speaking in an official capacity for an organization defined as a ring. In yet another example the members of a ring may have a limited trust relationship and, hence, senders that belong to that ring may wish to remain anonymous when they send messages to other ring members. Of course, the preceding examples are just a few of many possible scenarios consistent with claimed subject matter.

FIG. 6 illustrates an item 900, in this example an email message, wherein, in accordance with some implementations of claimed subject matter, a message may be identified (e.g., marked) as being associated with or originating from a particular relationship ring.

Further, in accordance with some implementations of claimed subject matter, an item, such as an email message, sent from a contact belonging to a particular ring does no have to be addressed to that ring, or, for that matter, to any other ring.

FIG. 7 illustrates an example email message 1000 wherein, in accordance with some implementations of claimed subject matter, a message may be identified (e.g., marked) as being associated with or originating from a particular relationship ring (e.g., the “Regulatory Board” ring) but may be sent to contacts outside the ring (e.g., to “Licensees” affected by actions of the “Regulatory Board” ring). In the example of FIG. 7, if a recipient of message 1000 replies to the ring:TDPS, the reply message may be delivered to all members of ring:TDPS. In some further implementations rules may cause a response from a licensee receiving message 1000 to be routed to an email account created especially for handling replies from license holders.

In accordance with some implementations, ring networks may be hierarchical in format. For example, a “family” ring or group may be further broken down into sub-rings or sub-groups such as “immediate family” (such as wife, son, daughter, etc.), and “extended family” (such as mom, dad, uncle, cousin, etc.). Such hierarchical groupings may extend for multiple levels of sub-rings; for example, “cousins” in an extended family ring might open up or be selectable to reveal a sub-ring providing a list of all cousins. Clearly, many such hierarchical ring scenarios are possible.

In such implementations, contact lists may be organized hierarchically amongst relationship rings and/or their sub-rings. Because one or more contacts may belong to multiple rings, it may be possible to associate items categorized by emotient attributes such as relationship rings with multiple conceptual indices. For example, in some implementations of claimed subject matter, the concept and/or term associated with a “role” as described herein may also comprise the name of a relationship ring. For instance, a contact in a “family” ring may play the role of “brother”. Clearly, a user may have multiple brothers. Thus, in some implementations of claimed subject matter, the term “brother” may comprise a description of a contact's role as a user's brother and/or comprise a name of a distinct relationship ring that contains all of the user's brothers. Hence, in accordance with claimed subject matter, r-smart criteria used to filter, search or archive stored items may simultaneously comprise acting roles and relationship ring names.

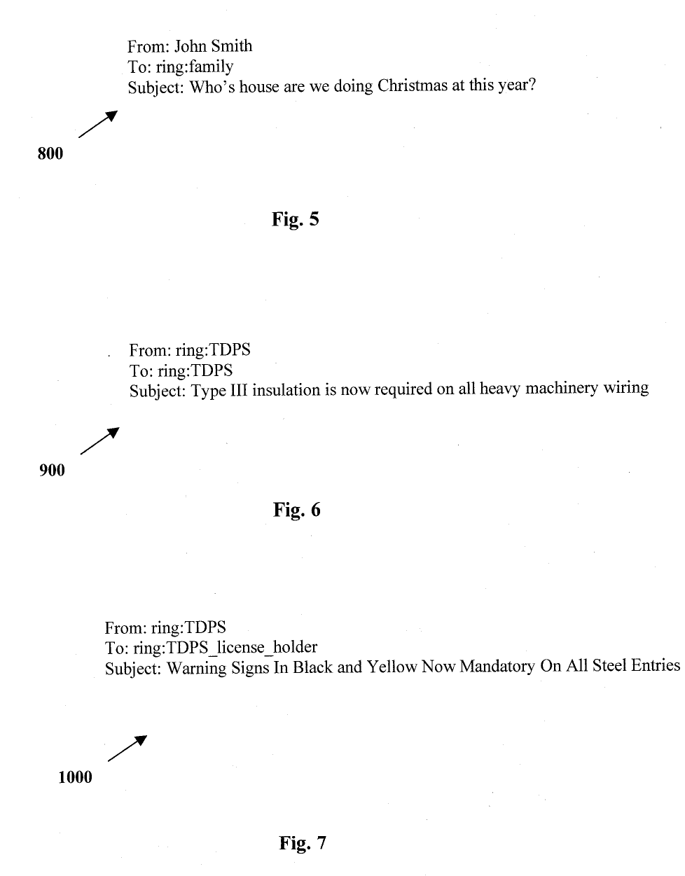

Furthermore, it is not necessary that a ring be a top-level ring or a sub-ring of another ring. Hence, in accordance with some implementations of claimed subject matter, relationship rings may comprise orthogonal rings that are independent of all other rings. In the context of orthogonal rings, when a sender, or a receiver, categorizes a item, or parts of an item, a plurality of relationship rings may be assigned to the item, so that the item may, correspondingly, be displayed in a plurality of contexts. Thus, for example, an item comprising a message from a user's brother may be displayed as associated with both the user's “family” ring, as well as in the user's “brother” ring. FIG. 8 illustrates relationship oriented items similar to those shown in FIG. 1, except that, in FIG. 8, a message 1100 from “Ann” is displayed associated with both the “important” and in “team members”. In this context indications associating an item with two rings may not comprise two different copies of the same item, but rather, may comprise the same item being referenced from two distinct points in an index into a database.

### Example System

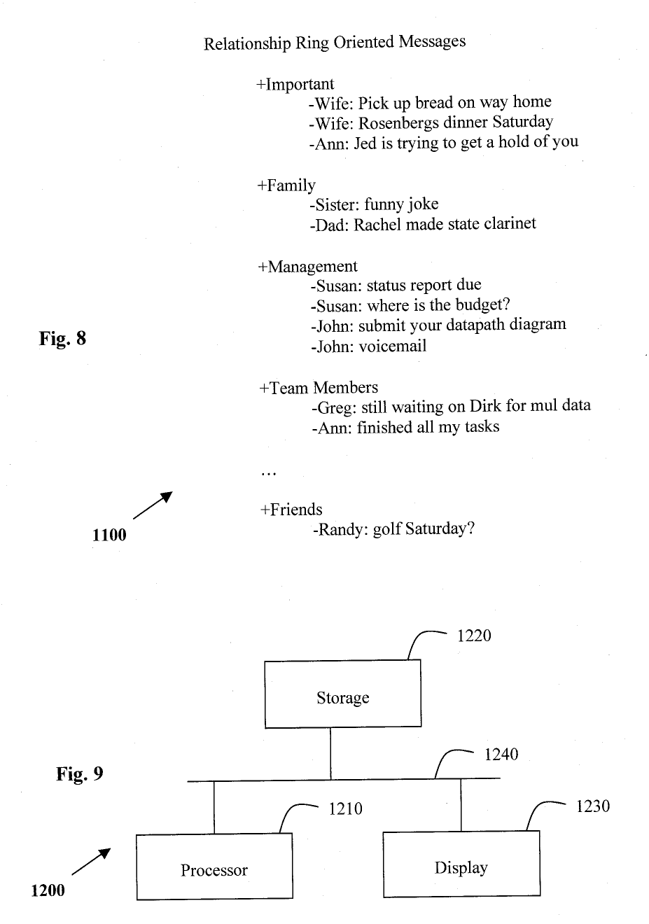

FIG. 9 is a block diagram of an example data storage system 1200. System 1200 may be used to perform some or all of the various functions discussed above in connection with FIGS. 1-8. System 1200 may comprise any device or collection of devices capable of facilitating storage of data and access thereto. For example, system 1200 may comprise a desktop computer, a laptop computer, a handheld computer, a smart and/or cellular telephone, a PDA, etc.

System 1200 includes a central processing unit (CPU) 1210 such as a processor capable of providing and/or facilitating data management functions, storage 1220 coupled to CPU 1210, and a display device 1230 coupled to CPU 1210 and/or storage 1220. Further, CPU 1210, display 1230 and storage 1220 may be coupled together by a communications pathway or bus 1240. It will be recognized by those skilled in the art that a graphics processing unit (GPU), not shown in FIG. 9, may be coupled to CPU 1210 and/or may be internal to CPU 1210, and may be coupled to display device 1230 in order to provide display device 1230 with displayable information. Such displayable information may be presented on display device 1230 in the form of a GUI where that GUI may be capable of providing visual representations of r-smart person-centric networks, emotient managers, indicators associated with stored items etc. in accordance with some implementations of claimed subject matter.

In accordance with some implementations of claimed subject matter, CPU 1210 may include logic to facilitate, build, generate and/or operate on internal representations such as list structures, data structures and/or arrays used to define r-smart person-centric networks, to organize stored items associated with emotient attributes, to associate emotient attributes with items, and/or to alter emotient attributes associated with items. Further, in accordance with some implementations of claimed subject matter, storage 1220 may act in conjunction with CPU 1210 to store or hold at least portions of such internal representations. In this context, storage 1220 and/or CPU 1210 may act to provide the functionality of a database for storing items associated with emotient attributes. Hence, storage 1220 may store items that are to be sorted, searched, and/or archived in response to r-smart criteria such as emotient attributes.

Those skilled in the art will recognize that storage 1220 and/or CPU 1210 may be further coupled to one or more controllers, not shown in FIG. 9, that may facilitate the communication of information, such as information specifying a GUI, between CPU 1210 and/or storage 1220. Further, storage 1220, which may be any device or collection of devices that provide for the storage of data. For example, storage 1220 may comprise a hard disk drive (HDD) or some other magnetic storage media or may comprise optical storage technology. Alternatively, storage 1220 may comprise memory internal to CPU 1210, and/or may comprise one or more discrete memory devices external to CPU 1210. Further, storage 1220 may comprise any other memory technology (e.g., random access memory (RAM), flash memory, etc.). In accordance with some implementations of claimed subject matter, storage 1220 may, at least temporarily, store or hold information capable of providing visual representations of r-smart person-centric networks and/or indicators (e.g., icons) associated with stored items. Such information may comprise, for example, information specifying at least portions of a GUI capable of providing visual representations of r-smart person-centric networks and/or arrangements or collections of stored items and capable of being displayed on display device 1230.

Display device 1230, which may comprise any type of display device such as a Liquid Crystal Display (LCD) display, a polymer-based display, an electroluminescent display, a Plasma Display Panel (PDP), or a Cathode Ray Tube (CRT) display, to name a few of the more prominent examples. Although example system 1200 is shown with a particular configuration of components, other implementations are possible using any of a wide range of configurations. Further, those skilled in the art will recognize that system 1200 may include many additional components such as communications buses etc., not particularly germane to claimed subject matter, that have not been illustrated in FIG. 9 in the interests of not obscuring claimed subject matter.

### Example Methods

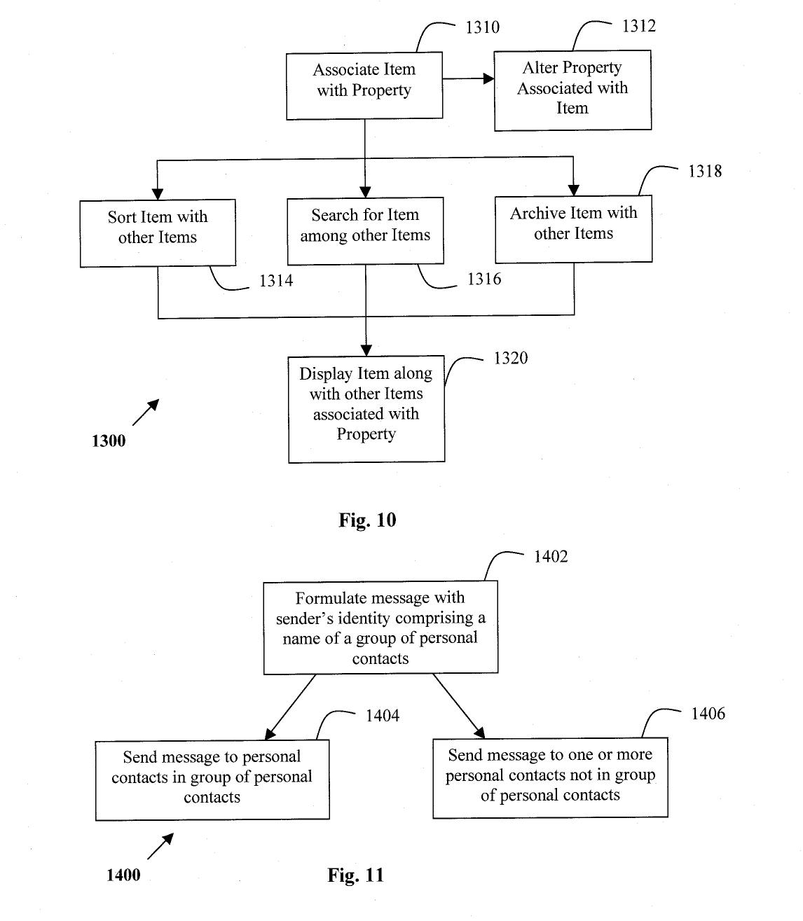

FIGS. 10 and 11 are flow diagrams of example respective methods 1300 and 1400 in accordance with some implementations of claimed subject matter. Methods 1300 and/or 1400 may implement and/or perform some or all of the various functions and/or schemes discussed above in connection with FIGS. 1-9 and details regarding at least portions of the various acts of methods 1300 and 1400 have been provided above in reference to those figures and may not be repeated below in the discussion of FIGS. 10 and 11. Any ordering of the acts shown in FIGS. 10 and 11 does not limit claimed subject matter and does not imply that the acts must be undertaken in the order shown and/or that any particular act in either of FIG. 10 or 11 is necessarily dependent upon another act. Further, in the description of FIGS. 10 and 11 that follows, references to the display of items may refer to display of an associated item header along with an item or to display of an associated item header alone. Similarly, while some acts of FIGS. 10 and/or 11 may call for display of an item, those skilled in the art will recognize that display of an item may comprise display of an indicator of an item such as an item header.

With regard to FIG. 10 and method 1300, an item may be associated with a property in act 1310. In act 1312 the property associated with the item may be altered. In acts 1314-1318, the stored item may be respectively sorted, searched for, or archived. In act 1320 the item, or an indicator thereof, may be displayed (e.g., on a display of a terminal device).

With regard to FIG. 11 and method 1400, a message may be formulated in act 1402 where that message includes an indicator of a sender of the message comprising a name of a group of personal contacts. In act 1404 the message may be sent to one or more personal contacts in the group of personal contacts, while in act 1406 the message may be sent to one or more personal contacts not in the group of personal contacts.

While particular implementations have just been described, claimed subject matter is not limited in scope to one or more particular implementations. For example, some implementations may be in hardware, such as employed to operate on a device or combination of devices, for example, whereas other implementations may be in software. Further, some implementations may be employed in firmware, or as any combination of hardware, software, and/or firmware, for example. Likewise, although claimed subject matter is not limited in scope in this respect, some implementations may comprise one or more articles, such as a storage medium or storage media. This storage media, such as, one or more CD-ROMs, computer disks, flash memory, or the like, for example, may have instructions stored thereon, that, when executed by a system, such as a computer system, computing platform, or other system, for example, may result in execution of an implementation of a method in accordance with claimed subject matter, such as one of the implementations previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations. Also, as used herein, the article “a” includes one or more items. Moreover, when terms or phrases such as “coupled” or “responsive” or “in response to” or “in communication with” are used herein or in the claims that follow, these terms should be interpreted broadly. For example, the phrase “coupled to” may refer to being communicatively, electrically and/or operatively coupled as appropriate for the context in which the phrase is used.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now, or in the future, occur to those skilled in the art. It is, therefore, to be understood that the appended claims are intended to cover all such modifications and/or changes as fall within the true spirit of claimed subject matter.

What is claimed:

1. A method, comprising:
associating a stored item with a property comprising at least one of a familiarity, affection, respect, esteem, status, and acting role.

2. The method of claim 1, further comprising sorting the stored item with other stored items in response to criteria including the property.

3. The method of claim 1, further comprising archiving the stored item along with other stored items associated with the property.

4. The method of claim 1, further comprising searching for the stored item among other stored items in response to criteria including the property.

5. The method of claim 4, wherein searching comprises searching content of the stored item.

6. The method of claim 5, wherein the stored item comprises a message, and wherein searching content comprises searching message content.

7. The method of claim 6, wherein the property is associated with a personal contact that sent the message.

8. The method of claim 7, wherein the property indicates a relationship ring membership of the personal contact.

9. The method of claim 1, wherein the stored item comprises a message, and wherein the property is included in a header associated with the message.

10. The method of claim 1, wherein the stored item comprises a message, wherein the message conveys an identity of a personal contact, and wherein the identity of the personal contact comprises an anonymous identity, or the property.

11. The method of claim 1, further comprising:
displaying the stored item along with only other stored items associated with the property.

12. The method of claim 11, wherein displaying the stored item along with only other stored items comprises displaying an indicator associated with the stored item along with indicators associated with the other stored items.

13. The method of claim 1, wherein associating a stored item with a property comprises at least one of indexing content, indexing metadata, indexing a keyword and indexing a tag.

14. The method of claim 1, wherein the property comprises an emotient attribute.

15. The method of claim 1, further comprising:
altering the property associated with the stored item.

16. The method of claim 1, wherein associating a stored item with a property comprises generating an index referencing a database.

17. The method of claim 1, wherein the database is contained in one of a computer, a telephone, and a personal digital assistant.

18. An article comprising: a storage medium having stored therein instructions that, if executed, result in:
associating a stored item with a property comprising at least one of a familiarity, affection, respect, esteem, status, and acting role.

19. The article of claim 18, the storage medium having stored therein instructions that, if executed, further result in:
sorting the stored item with other stored items in response to criteria including the property.

20. The article of claim 18, the storage medium having stored therein instructions that, if executed, further result in:
archiving the stored item along with other stored items associated with the property.

21. The article of claim 18, the storage medium having stored therein instructions that, if executed, further result in:
searching for the stored item among other stored items in response to criteria including the property.

22. The article of claim 21, wherein the stored item includes content, the storage medium having stored therein instructions that, if executed, further result in:
searching content of the stored item.

23. The article of claim 21, wherein the stored item comprises a message, the storage medium having stored therein instructions that, if executed, further result in:
searching message content.

24. The article of claim 23, wherein the property is associated with a personal contact that sent the message.

25. The article of claim 23, wherein the property indicates a relationship ring membership of the personal contact.

26. The article of claim 18, wherein the stored item comprises a message, and wherein the property is included in a header associated with the message.

27. The article of claim 18, wherein the stored item comprises a message, wherein the message conveys an identity of a personal contact, and wherein the identity of the personal contact comprises an anonymous identity, or the property.

28. The article of claim 18, the storage medium having stored therein instructions that, if executed, further result in:
displaying the stored item along with only other stored items associated with the property.

29. The article of claim 28, wherein the instructions to display the stored item along with only other stored items associated with the property, if executed, result in:
displaying an indicator associated with the stored item along with indicators associated with the other stored items.

30. The article of claim 18, wherein the instructions to associate a stored item with a property, if executed, result in:
at least one of indexing content, indexing metadata, indexing a keyword and indexing a tag.

31. The article of claim 18, wherein the property comprises an emotient attribute.

32. The article of claim 18, the storage medium having stored therein instructions that, if executed, further result in:
altering the property associated with the stored item.

33. The article of claim 18, wherein the instructions to associate a stored item with a property, if executed, result in:
generating an index referencing a database.

34. The article of claim 33, wherein the database is contained in one of a computer, a telephone, and a personal digital assistant.

35. An apparatus, comprising:
a terminal device having logic adapted to associate an item with a property comprising at least one of a familiarity, affection, respect, esteem, status, and acting role;
the terminal device further having logic adapted to store the item; and
the terminal device further having logic adapted to sort the item against other stored items in response to criteria including the property.

36. The apparatus of claim 35, wherein the item is associated with a personal contact of a user of the terminal device.

37. The apparatus of claim 36, wherein the property indicates a relationship ring membership of the personal contact.

38. The apparatus of claim 35, wherein the item comprises a message, and wherein the property is included in a header associated with the message.

39. The apparatus of claim 35, the terminal device further having logic adapted to:
display an indicator of the stored item along with indicators of other items associated with the property.

40. The apparatus of claim 35, wherein the logic adapted to associate an item with a property is adapted to index content, metadata, a keyword and/or a tag associated with the item.

41. The apparatus of claim 35, wherein the logic adapted to associate an item with a property is adapted to generate an index referencing a database.

42. The apparatus of claim 35, wherein the terminal device comprises one of a computer, a telephone, and a personal digital assistant.

43. The apparatus of claim 35, the terminal device further having logic adapted to:
search for the stored item amongst other stored items in response to criteria including the property

44. The apparatus of claim 35, the terminal device further having logic adapted to:
archive the stored item along with other stored items associated with the property.

45. A system, comprising:
a processor;
storage coupled to the processor; and
a display coupled to the processor;
wherein the processor is adapted to associate an item with a property comprising at least one of a familiarity, affection, respect, esteem, status, and acting role;
the processor further adapted to store the item in the storage; and
the processor further adapted to sort, in response to criteria including the property, the item against other items stored in the storage.

46. The system of claim 45, wherein the item is associated with a personal contact of a user of the system.

47. The system of claim 46, wherein the property indicates a relationship ring membership of the personal contact.

48. The system of claim 45, wherein the item comprises a message, and wherein the property is included in a header associated with the message.

49. The system of claim 45, the processor further having logic adapted to:
display an indicator of the stored item along with indicators of other items associated with the property.

50. The system of claim 45, wherein the logic adapted to associate an item with a property is adapted to index content, metadata, a keyword and/or a tag associated with the item.

51. The system of claim 45, wherein the logic adapted to associate an item with a property is adapted to generate an index referencing a database.

52. The system of claim 45, wherein the processor is contained in one of a computer, a telephone, and a personal digital assistant.

53. The system of claim 45, the processor further having logic adapted to:
search for the stored item amongst other stored items in response to criteria including the property

54. The system of claim 45, the processor further having logic adapted to:
archive the stored item along with other stored items associated with the property.
